(19) United States
(12) Patent Application Publication
(10) Pub. No.: US 2008/0231973 A1
(43) Pub. Date: Sep. 25, 2008

(54) MECHANISM FOR A MICROSCOPE OBJECTIVE CHANGER AND FILTER CHANGER

(75) Inventor: Wei Guo, Unionville, CT (US)

Correspondence Address: KELLEY DRYE & WARREN LLP, 400 ALTLANTIC STREET , 13TH FLOOR, STAMFORD, CT, 06901, US

(73) Assignee: Ikonisys, Inc., New Haven, CT (US)

(21) Appl. No.: 11/833,154

(22) Filed: Aug. 2, 2007

Related U.S. Application Data
(60) Provisional application No. 60/821,532, filed on Aug. 4, 2006.

(51) Int. Cl. G02B 7/02

(52) U.S. Cl. 359/821

(57) ABSTRACT

A mechanism is disclosed for incorporation into automatic microscope which permits the interchanging of optical path components such as objective lens assemblies, filters, and imaging devices. The mechanism features good placement accuracy and repeatability to permit the maintenance of system calibrations.

This application claims priority from U.S. Provisional Application Ser. No. 60/821,532, filed Aug. 4, 2006. All references cited in this specification, and their references, are incorporated by reference herein where appropriate for teachings of additional or alternative details, features, and/or technical background.

### BACKGROUND OF THE INVENTION

1. Field of Invention

The present invention generally relates to remotely operated or robotically controlled microscopes, in general, and specifically the mechanization of a means for automatically interchanging objective lens assemblies, filters and/or other optical components.

2. Description of Related Art

The application of automated microscope based analysis, in many fields including medicine, frequently requires the capability to interchange optical assemblies during the course of the protocol. These assemblies can include, for example, objective lenses, filters, eyepieces and imaging devices. For example, it may be required to change magnification during the course of an experiment. The new field of view resulting from the objective lens change must not displace picture elements of the resulting image from the previous field of view. The interchange must therefore be performed so as to accurately place the optical assembly with excellent repeatability and a minimum of vibration, so as not to disturb the alignment of other components in the optical path or the calibration of the system. For many applications, the interchange process must be completed within tight time constraints imposed by results timeliness requirements and experiment stability limitations.

The mechanism must also be small to minimize the inertia, thereby enhancing kinematic properties of the system and also to not interfere with the placement of other critical components in the system. Contaminants may deposit on surfaces of various optical elements and/or may fall on the specimen being observed, thus damaging it. The potential for the introduction of contaminants should be minimized through the employment of a lubricant-free design. Critical to the practicality of the system is the requirement for a superior mean-time-to-failure and ease of repair.

In addition to the requirements imposed on the mechanism for efficient interchange of optical path assemblies, the normal performance of the microscope must be preserved. Numerous factors must be dealt with in microscopy, including resolution, contrast, depth of focus, working distance, magnification, parfocality, and parcentricity. Resolution refers to the ability to distinguish in an image two adjacent points as two separate points. Resolution is important to distinguish features in a sample. Resolution may decrease with magnification, and is typically related to the numerical aperture of the objective. Contrast is also necessary in the evaluation of an image. Contrast is the difference in intensity between the brightest point in an image and the darkest point in the image, or the relative intensity of the zero order versus the diffracted orders. Without sufficient contrast, an image may appear “flat” at best, or invisible at worst. Contrast is conventionally controlled in a manual microscope by way of a condenser diaphragm. Depth of focus refers to the depth of the image along the optical axis that is in focus. Depth of focus changes as the numerical aperture of the objective changes, and the working distance of the objective changes (as the working distance of the objective is increased, the depth of focus increases). The depth of focus is important in that objects within the specimen that are outside the depth of focus are poorly resolved and not detected. Working distance refers to the distance from the front of the objective to the specimen plane. When objectives are changed, the working distance (particularly when the objective has a different numerical aperture) may change as well as focus. It is generally important to keep the working distance sufficient so as not to have the objective interfered by the specimen proper. Parfocality refers to an image of a specimen staying in focus when the objective is changed, and parcentricity refers to maintaining an object in the center of the field regardless of which objective is being used. Parfocality and parcentricity are also generally desirable in the design of a microscope system.

An apparatus for changing objective lenses in a microscope is disclosed in U.S. Pat. No. 6,525,876, Gilbert, et al., Feb. 25, 2003. The patent describes an apparatus for changing objective lenses in a microscope. The disposition of the objective lens turret in the microscope makes it possible to avoid damaging manipulators or samples during an objective lens change. According to Gilbert, the damage is avoided due to a lateral tilt of the rotational axis of the objective lens turret relative to the first and the second side walls of the microscope. The entire process of changing the objective lens described in Gilbert, as well as the magnification setting and focusing necessary for the purpose, is performed in a completely automatic and motorized fashion. The apparatus disclosed in U.S. Pat. No. 6,525,876, however, may impart significant vibration on the microscope and does not provide adequate application flexibility to satisfy the requirements delineated above.

### SUMMARY OF THE INVENTION

Embodiments herein include:

A changer for changing the optics in an optical path, the changer comprising: a wheel having a plurality of emission translucent optical path altering elements thereon, at least one of the elements which alters the optical path of an electromagnetic wave different from another element on the wheel, the wheel defining gaps between each of the optical path altering elements; a base; and a lever arm having a first lever and a second lever end and a pivot therebetween, both the first lever end and second lever end each having a protruding post antipodal to the base, the distance between the first lever post and the second lever post being more than the distance of adjacent gaps on the wheel, the lever arm attached to the base by the pivot and operatively configured to interact with the wheel such that rotational movement about the lever pivot causes the lever posts to move between the adjacent gaps, causing the wheel to rotate.

An apparatus for interchanging optical components in an optical path, the apparatus comprising:
a control motor having a rotatable motor shaft;
a support structure supporting the control motor;
a planar base defined by a periphery that is generally symmetric about a central point on the planar base, the planar base comprising a plurality of mounting fixtures mounting a plurality of optical components equi-angularly placed at a same distance from the base center and spaced between each other by radial slots penetrating toward the central point from the periphery;
a lever arm having a first lever end and a second lever end, the first lever end and the second lever end each having a protruding post oriented perpendicular to the longest axis of the lever, the lever arm operatively connected to the rotatable motor shaft at a point between the first lever end and the second lever end and to the planar base by articulation at a point in time of one or more of the protruding posts with one or more of the radial slots in the planar base, the protruding posts each being positioned with one another to permit engagement with one radial slot at one point in time and with another radial slot at another point in time as the lever arm is rotated by the rotatable motor shaft of the motor and to cause generally symmetric rotation of the planar base about its center.

Embodiments further comprise a control motor controller; and at least one sensor operatively configured to determine position of the generally round planar base and report the position to the servo motor controller. The components may be filters, lenses or lens assemblies, mirrors, optical fibers, irradiation sources and image capture devices.

### BRIEF DESCRIPTION OF THE DRAWINGS

FIG. 1. Schematic representation of an embodiment of an apparatus for interchanging optical components.

FIG. 2. Schematic representation of an embodiment of an apparatus for interchanging optical components.

FIG. 3. Schematic representation of an embodiment of an apparatus for interchanging optical components.

FIG. 4. Schematic representation of certain elements in an apparatus for interchanging optical components.

FIG. 5. Schematic representation of certain elements in an apparatus for interchanging optical components.

### DETAILED DESCRIPTION OF THE INVENTION

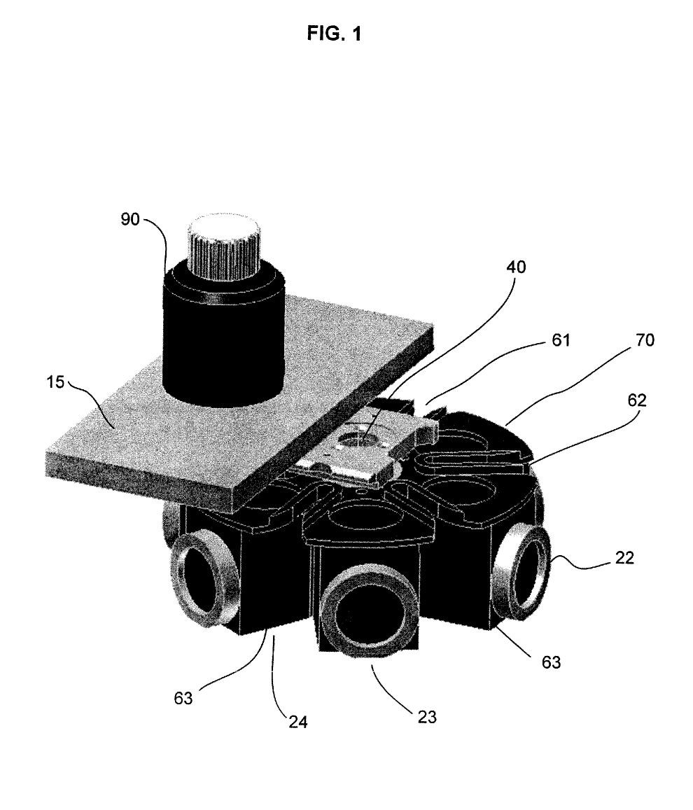

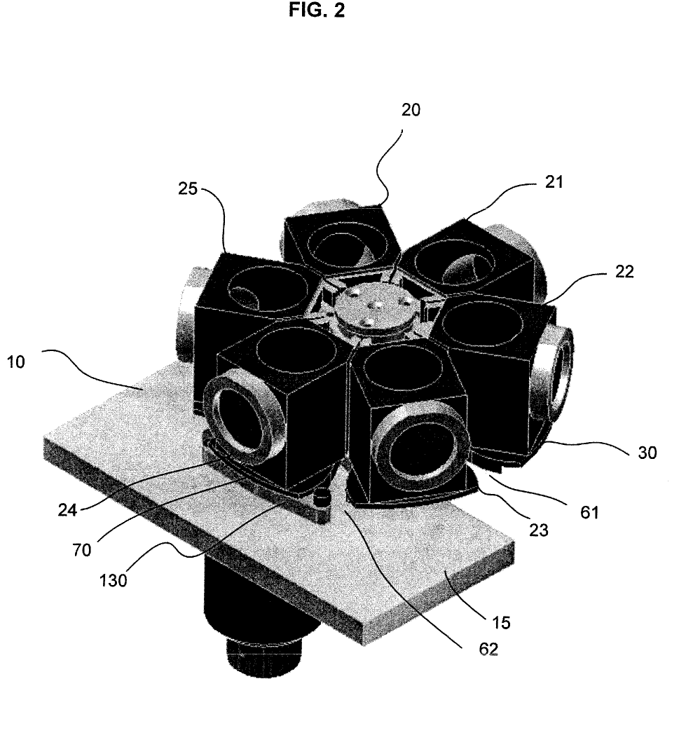

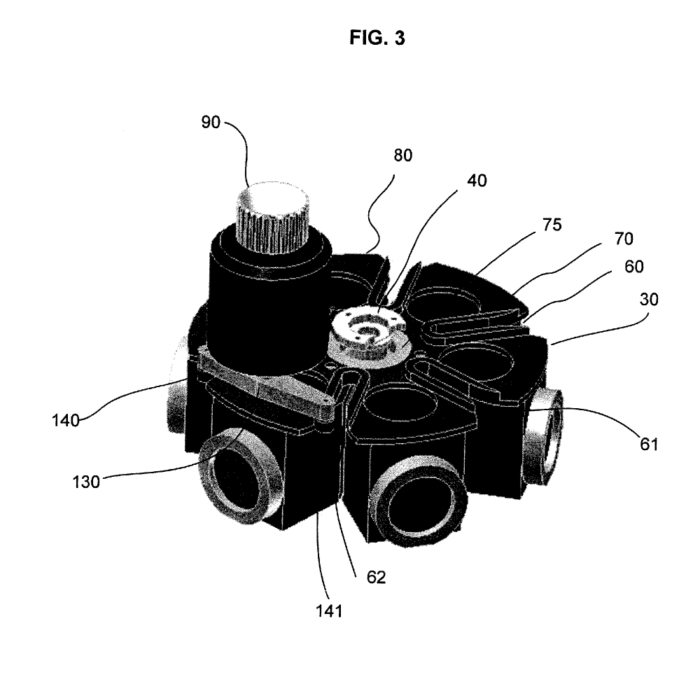

Turning to FIGS. 1, 2 and 3, there is disclosed an embodiment of an apparatus for automatically inserting an optical component, selected from a plurality of optical components, into the optical path of a microscope. FIGS. 1, 2 and 3 show such an apparatus from three different perspectives.

As indicated in FIGS. 1, 2 and 3, six interchangeable optical components, such as objective lens assemblies 20, 21, 22, 23, 24, 25, are mounted on a surface of base 30 of a carousel 10 so that base 30 can rotate about central bearing 40 in turntable fashion. Central bearing 40 is rotatably connected to structure of microscope 15 so as to permit the positioning of each of the objective lens assemblies 20, 21, 22, 23, 24, 25 in line with the optical axis of the microscope as determined by the rotational position of the carousel 10. While six assemblies 20, 21, 22, 23, 24, 25 are shown for illustrative purposes, other numbers of assemblies may be similarly configured in other applications. Base 30 of carousel 10 has six equi-angularly spaced, open ended radial cutout slots 60, 61, 62, 63, 64, 65 extending from perimeter 70 of the carousel toward the center of carousel 75 forming cogwheel 80.

The carousel is rotated as described below. As the carousel is rotated, one of the optical path component assemblies 20, 21, 22, 23, 24, 25 is moved into alignment with the microscope's optical axis.

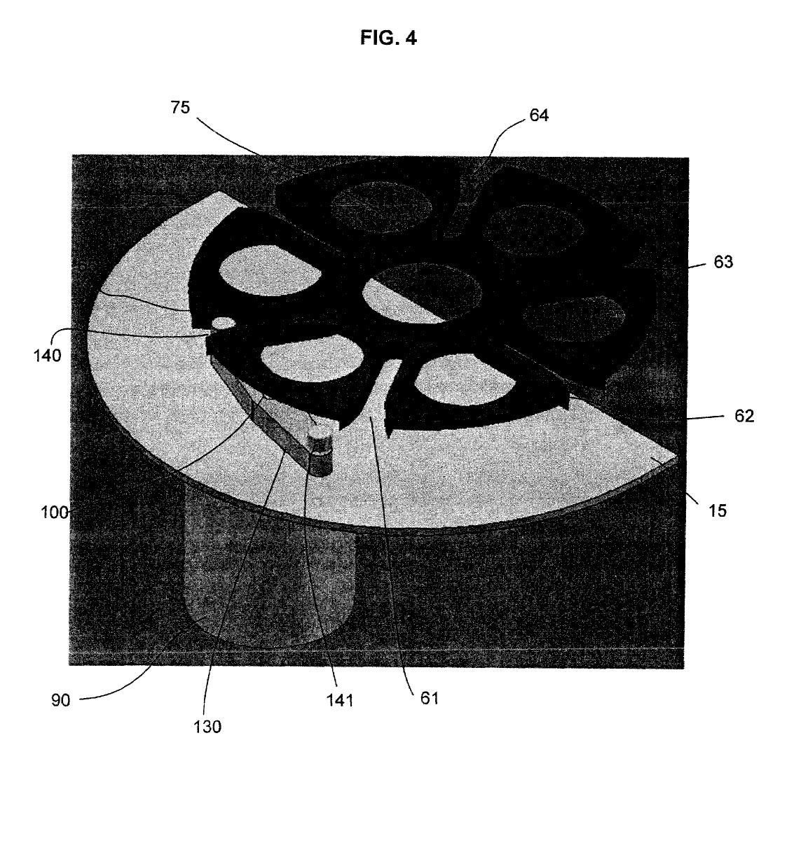

Control motor 90 is mounted to the structure of microscope 15 with its rotating shaft 100 protruding through a shaft coupling in the base. A slot in the base permits adjustment of the motor position. Two-armed lever 130 is attached to protruding motor shaft 100 so that at least one of the two pins or posts, 140, 141, on the arms of lever 130 engages an open ended radial cutout slot 60, 61, 62, 63, 64, 65 of the carousel one at a time, as shown in FIG. 4. The posts and the slots are mutually fabricated to engage one another as snugly as possible, thereby minimizing backlash or slack. In this way parfocality and parcentricity are optimally preserved as optical components are interchanged by the apparatus.

FIG. 4, which is a partial view illustrating the interrelationship of key components, with objective assemblies 20, 21, 22, 23, 24, 25 removed from the diagram for clarity. Referring to FIG. 4, as control motor 90 rotates two-armed lever 130 via its shaft 100, one of pins 140 enters one of radial slots 120, proceeds down slot 60 toward the center of carousel 75 then retreats back out of slot 60. As the first pin 140 exits slot 60, the second pin 141 engages the next radial slot 61. In this way, carousel 10 is made to rotate as determined by the motion of shaft 100 of control motor 90.

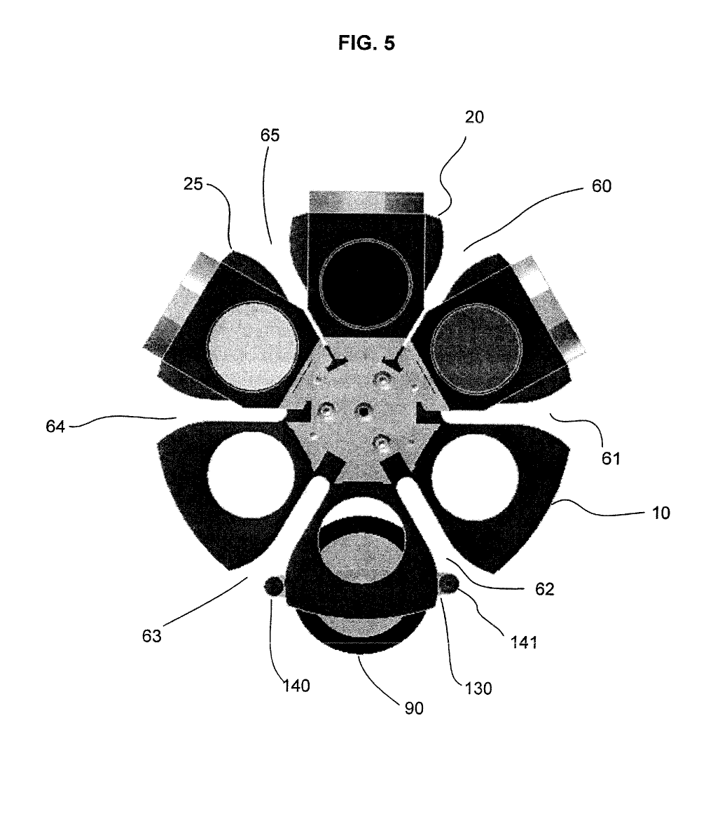

The mouths of the radial slots 60, 61, 62, 63, 64, 65 near the periphery of the carousel are shaped so that movement of the carousel is prevented by the two pins or posts, 140 and 141, when lever 130 is positioned perpendicularly to a diameter of carousel 10 that passes through a center of the corresponding optical component, as shown in FIG. 5. This positioning corresponds to the desired optical alignment for one of the objective lens assemblies.

Sensors are included in the mechanism to detect motor shaft 100 position thereby permitting the incorporation of feedback to control the position of carousel 10. Alternatively, sensors may be included that detect the rotational position of the carousel 10, which likewise can provide a feedback signal to control its rotational position.

While this description has referred to objective lens assemblies, for purposes of illustration, the mechanism is equally applicable to other optical path assemblies such as filters, lenses and lens assemblies, mirrors, optical fibers, illumination sources and imaging devices.

In various embodiments, the interchangeable apparatus described herein may include two optical components, or three optical components, or four optical components, or five optical components, or six optical components, or even more. In each such embodiment the optical components are preferably disposed at identical angles about the carousel 10 with respect to each other.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the to the invention without departing from the spirit or scope of the invention as defined by the appended claims.

We claim:

1. A changer for changing the optics in an optical path, said changer comprising:
a wheel having a plurality of emission translucent optical path altering elements thereon, at least one of said elements which alters the optical path of an electromagnetic wave different from another element on said wheel, said wheel defining gaps between each of said optical path altering elements;
a base, and
a lever arm having a first lever end and a second lever end and a pivot there between, both said first lever end and second lever end each having a protruding post orthogonal to said base, wherein the distance between the first lever post and the second lever post being more than the distance of adjacent gaps on said wheel, said lever arm attached to said base via said pivot and operatively configured to interact with said wheel such that rotational movement about the lever pivot causes the lever posts to move between said adjacent gaps, causing said wheel to rotate.

2. An apparatus for interchanging optical components in an optical path, said apparatus comprising:
a control motor having a rotatable motor shaft;
a support structure supporting said control motor;
a planar base defined by a periphery that is generally symmetric about a central point on the planar base, said planar base comprising a plurality of mounting fixtures mounting a plurality of optical components equi-angularly placed at a same distance from the base center and spaced between each other by radial slots penetrating toward said central point from said periphery;
a lever arm having a first lever end and a second lever end, said first lever end and said second lever end each having a protruding post oriented perpendicular to the longest axis of the lever, said lever arm operatively connected to said rotatable motor shaft at a point between said first lever end and said second lever end and to said planar base by articulation at a point in time of one or more of said protruding posts with one or more of said radial slots in said planar base, said protruding posts each being positioned with one another to permit engagement with one radial slot at one point in time and with another radial slot at another point in time as said lever arm is rotated by said rotatable motor shaft of said motor and to cause generally symmetric rotation of the planar base about its center.

3. The apparatus of claim 2 wherein each slot is centered on a radius positioned along an angle bisecting the angle formed by a radius passing through a center defined for each of two adjacent mounting fixtures, said slots having a length less than the radius of said generally rotationally symmetric planar base.

4. The apparatus of claim 2 further comprising:
a control motor controller, and
at least one sensor operatively configured to determine the rotational position of said planar base and report said position to said control motor controller.

5. The apparatus of claim 2 wherein at least one of said optical components is an optical filter.

6. The apparatus of claim 2 wherein at least one of said optical components is a lens or a lens assembly.

7. The apparatus of claim 2 wherein at least one of said optical components is an irradiation source.

8. The apparatus of claim 2 wherein at least one of said optical components is an image capture device.

9. The apparatus of claim 2 wherein at least one of said optical components is a mirror.

10. The apparatus of claim 2 wherein at least one of said optical components is an optical fiber.

11. The apparatus of claim 2 wherein at least one of said optical components comprises a plurality of optical elements selected from the group consisting of an optical filter, a lens, a lens assembly, an irradiation source, an image capture device, a mirror, and an optical fiber.

12. The apparatus of claim 2 wherein said control motor is selected from the group consisting of a servo motor, a stepper motor, and a synchronous motor.

13. The apparatus of claim 2 wherein said rotatable motor shaft rotates in both clockwise and counterclockwise directions.
